(19) United States
(12) Patent Application Publication
(10) Pub. No.: US 2013/0221861 A1
(43) Pub. Date: Aug. 29, 2013

(54) METHOD AND DEVICE FOR DRIVING AN LED STRING

(71) Applicants: Martinus Petrus Creusen, Eindhoven (NL); Ralph Kurt, Eindhoven (NL); Haimin Tao, Eindhoven (NL); Carsten Deppe, Eindhoven (NL); Georg Sauerlaender, Eindhoven (NL); Peter Hubertus Franciscus Deurenberg, Eindhoven (NL)

(72) Inventors: Martinus Petrus Creusen, Eindhoven (NL); Ralph Kurt, Eindhoven (NL); Haimin Tao, Eindhoven (NL); Carsten Deppe, Eindhoven (NL); Georg Sauerlaender, Eindhoven (NL); Peter Hubertus Franciscus Deurenberg, Eindhoven (NL)

(73) Assignee: KONINKLIJKE PHILIPS ELECTRONICS N.V., EINDHOVEN (NL)

(21) Appl. No.: 13/882,636

(22) PCT Filed: Oct. 24, 2011
(86) PCT No.: PCT/IB2011/054731

§ 371 Date: Apr. 30, 2013

(30) Foreign Application Priority Data
Nov. 2, 2010 (EP) 10189656.1

(51) Int. Cl. H05B 33/08

(52) U.S. Cl. CPC H05B 33/0821; H05B 33/083
USPC 315/193; 315/185 R

(57) ABSTRACT

The invention relates to a method and a device for driving an LED string of a first LED segment (11) and at least one further LED segment (12, 13, 14) connected in series. Each LED segment has at least one light emitting diode, LED. The LED string is powered by a rectified AC mains voltage. The first LED segment (11) is powered when the rectified AC mains voltage is above a first voltage level, and the first LED segment and the further LED segment are powered when the rectified AC mains voltage is above a second voltage level higher than the first voltage level. The first LED segment emits light having a first color temperature, and the further LED segment emits light having a second color temperature higher than the first color temperature. The light emitted by the first LED segment and the light emitted by the further LED segment are superimposed. The color temperature change of the light emitted by the LED string, when dimmed, resembles the color temperature change of an incandescent lamp.

### FIELD OF THE INVENTION

The invention relates to the field of LED lighting. More in particular, the invention relates to a method of driving an LED string, and to different embodiments of LED lighting modules.

### BACKGROUND OF THE INVENTION

In the field of LED lighting, mains compatible driver solutions that avoid bulky components, that have a small form factor and that may reduce costs, are strived for. Within the framework of such developments, incandescent lamps and other incandescent light modules used traditionally may be replaced by LED retrofits.

An incandescent light module is dimmed when it operates at a lower voltage than the nominal voltage for which it is designed. As the voltage is decreased, the lamp power and the light output decrease accordingly. A variable voltage for dimming an incandescent light module is produced by a dimming device coupled between an AC mains voltage and the light module. The dimmer may be a device for varying the voltage amplitude, however, usually it is a solid-state switching device, switching the AC mains voltage on and off at the mains voltage frequency, thereby supplying power pulses to the light module. The combined thermal mass and persistence of the filament(s) of the incandescent light module smoothes out the effect of the power pulses, and the human eye is relatively insensible to fluctuations of the light produced by the light module. As a result, the human eye perceives a dimmed light, which is more or less bright depending on the proportion of the time with voltage on to the time with voltage off In other words, by varying the average voltage, the light output of the light module is varied, and the light module may be dimmed in this way.

The dimmer operates by phase-cut dimming, either by switching voltage off during a first portion of a half cycle of the voltage, and switching voltage on during a last portion of a half cycle of the voltage (also indicated with forward phase-cut dimming), or by switching voltage on during a first portion of a half cycle of the voltage, and switching voltage off during a last portion of a half cycle of the voltage (also indicated with reverse phase-cut dimming). Forward phase-cut dimming is cheap, uses robust electronics, and is suitable for most loads, including not only incandescent light modules, but also magnetic transformers, neon lamps, cold cathode and other types of fluorescent lamps, and LED power supplies. Reverse phase-cut dimming is more expensive and requires more complex electronics, but some loads, such as electronic transformers, operate better and generate less audible noise when this type of dimming is used.

When a user sets a level of dimming at the dimmer (input), a light level results (output). In most dimmers, the output of the dimmer is not directly proportional to the input. Different dimmers produce different dimmer curves defining the relationship between level of dimming and light level. Dimming may comprise a range with a minimum, higher than zero, level of dimming for preventing a lamp to cool down too much and/or a maximum, lower than nominal, level of dimming for limiting ageing of the lamp.

Since many decades, people have been used to the light of incandescent lamps of different powers. The light of an incandescent lamp provides a general feeling of well-being. Generally, the lower the power of the incandescent lamp, the lower the color temperature of the light emitted by the lamp is. As a characterization, the human perception of the light is “warmer” when the color temperature is lower. With one and the same incandescent lamp, the lower the (average) power supplied to the lamp, which occurs when the lamp is dimmed, the lower the color temperature of the emitted light is. This behaviour resembles the performance of a sunset (and sunrise). If the light intensity of the sun decreases (dims) in the evening, the light also becomes more reddish/orange. These colors are perceived as warm colors.

U.S. Pat. No. 7,081,722 discloses a method and circuit for driving LEDs in multiphase. A string of LEDs divided into groups connected to each other in series is provided. Each group is coupled to ground through separate conductive paths. A phase switch is provided in each conductive path. Increasing the input voltage turns on the string of LEDs, group by group in the sequence down the string.

### SUMMARY OF THE INVENTION

It is an object of the invention to provide a method of driving an LED string, and to provide different embodiments of LED lighting modules, including lamps and luminaries comprising an LED string, and which are adapted to be coupled to a rectified AC mains voltage which may be dimmed, wherein the LED string, when dimming is applied, emits light having a lower color temperature than the light which is emitted by the LED string when dimming is not applied. Here, dimming comprises phase-cut dimming and voltage amplitude dimming.

In a first aspect of the invention, this object is achieved by a method of driving an LED string comprising a first LED segment and at least one further LED segment connected in series, each LED segment comprising at least one light emitting diode, LED, the LED string being powered by a rectified AC mains voltage, wherein the first LED segment is powered when the rectified AC mains voltage is above a first voltage level, and the first LED segment and the further LED segment are powered when the rectified AC mains voltage is above a second voltage level higher than the first voltage level, and wherein the first LED segment emits light having a first color temperature, and the further LED segment emits light having a second color temperature higher than the first color temperature, and the light emitted by the first LED segment and the the light emitted by the further LED segment are superimposed.

The LED string, hereinafter also referred to as LED module, comprises a plurality of LED segments connected in series. Each LED segment may comprise one or more LEDs mutually connected as desired. The voltage of each LED segment may be the same as, or different from, that of other segments. The number of LED segments in a LED string may be chosen differently, and is at least two.

The LED string may comprise one or more first LED segments emitting light having a first color temperature, and one or more further LED segments emitting light having a second color temperature. The first color temperature of light emitted by one first LED segment may differ from a first color temperature of light emitted by another first LED segment, and the second color temperature of light emitted by one further LED segment may differ from a second color temperature of light emitted by another further LED segment.

The first LED segment may emit red, orange, yellow or amber light, including any combination thereof, and including saturated or less saturated colors.

The different LED segments of the LED string are arranged in such a way that the light contributions of the different LED segments are optically superimposed, i.e. the light is mixed. The LED segments may e.g. be placed next to each other in a mixing chamber, or in a space with a diffuser or the like.

When the AC mains voltage is not dimmed, both the first LED segment(s) and the further LED segment(s) are powered during a half cycle of the mains voltage, where the mains voltage will exceed both the first voltage level and the second voltage level. When the AC mains voltage is dimmed, both the duration of powering the first LED segment(s) and the duration of powering the further LED segment(s) during a half cycle of the mains voltage are reduced. When the AC mains voltage is dimmed such that the first voltage level is exceeded but the second voltage level is not exceeded during a half cycle of the mains voltage, only the first LED segment(s) will be powered during the half cycle. Consequently, the lower the dimming, the more the first LED segment(s) will dominate the color temperature of the light emitted by the LED string. Since the first LED segment(s) emit(s) light having a first color temperature being lower than the second color temperature of the light emitted by the further LED segment(s), the perceived color temperature of the light emitted by the LED string will become lower when the mains voltage is dimmed. This is a desired behaviour of the LED string, similar to the color temperature behaviour of an incandescent lamp when dimmed.

In a second aspect of the invention, the above object is achieved by an LED lighting module, comprising:

an LED module comprising a string of a first LED segment and at least one further LED segment connected in series, wherein each LED segment comprises at least one light emitting diode, LED;

an LED driver circuit comprising:
LED driver input terminals adapted to be connected to a rectified AC mains voltage;
a switching device connected in parallel to each further LED segment;
a current control device connected between the LED driver input terminals;
control circuitry for controlling an open state or a closed state of each switching device, the control circuitry being adapted to control each switching device to have a closed state when the rectified AC mains voltage is below a predetermined voltage level, and to control the switching device connected to a further LED segment to have an open state when the rectified AC mains voltage is above the predetermined voltage level,

wherein the first LED segment emits light having a first color temperature, and the further LED segment emits light having a second color temperature higher than the first color temperature, and the light emitted by the first LED segment and the the light emitted by the further LED segment are superimposed.

In a third aspect of the invention, the above object is achieved by an LED lighting module, comprising:

an LED module comprising a string of a first LED segment and at least one further LED segment connected in series, wherein each LED segment comprises at least one light emitting diode, LED;

an LED driver circuit comprising:
LED driver input terminals adapted to be connected to a rectified AC mains voltage;
a switching device connected in parallel to the first LED segment, and a switching device connected in parallel to each further LED segment;
a current control device connected between the LED driver input terminals;
control circuitry for controlling an open state or a closed state of each switching device, the control circuitry being adapted to control the switching device connected in parallel to the first LED segment to have an open state and the switching device connected in parallel to a further LED segment to have a closed state when the rectified AC mains voltage is above a first voltage level and below a second voltage level higher than the first voltage level, and to control the switching device connected to a further LED segment to have an open state when the rectified AC mains voltage is above the second voltage level,

wherein the first LED segment emits light having a first color temperature, and the further LED segment emits light having a second color temperature higher than the first color temperature, and the light emitted by the first LED segment and the light emitted by the the further LED segment are superimposed.

In a fourth aspect of the invention, the above object is achieved by an LED lighting module, comprising:

an LED module comprising a string of a first LED segment and at least one further LED segment connected in series, wherein each LED segment comprises at least one light emitting diode, LED;

an LED driver circuit comprising:
LED driver input terminals adapted to be connected to a rectified AC mains voltage;
for each LED segment, a current control device connected between one terminal of the LED segment and an LED driver input terminal;
control circuitry for controlling a current in each current control device, the control circuitry being adapted to control the current control device of the first LED segment to allow a current to flow when the rectified AC mains voltage is above a first voltage level, and to disallow a current to flow when the rectified AC mains voltage is above a second voltage level higher than the first voltage level,

wherein the first LED segment emits light having a first color temperature, and the further LED segment emits light having a second color temperature higher than the first color temperature, and the light emitted by the first LED segment and the light emitted by the further LED segment are superimposed.

In all aspects of the invention, a special technical feature is that the first LED segment(s) will emit light having a first color temperature, and the further LED segment(s) will emit light having a second color temperature which is higher than the first color temperature, and the light emitted by the first LED segment and the light emitted by the further LED segment are superimposed. Also, the first LED segment(s) will be powered when the AC mains voltage exceeds a first voltage level, and the further LED segment(s) will only be powered when the AC mains voltage exceeds a second voltage level which is higher than the first voltage level.

### BRIEF DESCRIPTION OF THE DRAWINGS

The above and other aspects of the invention will be apparent from and elucidated with reference to the embodiments described hereinafter.

In the drawings:

FIG. 1a depicts a diagram of a first embodiment of an LED lighting circuit in which different modules are indicated by dash-dotted lines;

FIG. 1b depicts a diagram of a second embodiment of an LED lighting circuit in which different modules are indicated by dash-dotted lines;

FIG. 2 depicts currents in different LED segments, as a function of the phase angle in a half cycle of the (rectified) AC mains voltage in the LED lighting circuit according to FIG. 1a;

FIG. 3 depicts simulation results of the light output ratios of the different LED segments compared with the total light output of all LED segments, and the average current, at a variation of a phase-cutting angle α of the (rectified) AC mains voltage in the LED lighting circuit according to FIG. 1a at the currents depicted in FIG. 2;

FIG. 4 depicts a detail of FIG. 3;

FIG. 5 depicts currents in different LED segments, as a function of the phase angle in a half cycle of the (rectified) AC mains voltage in the LED lighting circuit according to FIG. 1b;

FIG. 6 depicts simulation results of the light output ratios of the different LED segments compared with the total light output of all LED segments, and the average current, at a variation of a phase-cutting angle α of the (rectified) AC mains voltage in the LED lighting circuit according to FIG. 1b at the currents depicted in FIG. 5;

FIG. 7 depicts currents in different LED segments, as a function of the phase angle in a half cycle of the (rectified) AC mains voltage in the LED lighting circuit according to FIG. 1a;

FIG. 8 depicts simulation results of the light output ratios of the different LED segments compared with the total light output of all LED segments, and the average current, at a variation of a phase-cutting angle α of the (rectified) AC mains voltage in the LED lighting circuit according to FIG. 1a at the currents depicted in FIG. 7; and

FIG. 9 depicts measured graphs of color temperature versus light intensity for an embodiment of an LED string, and for a GLS (incandescent lamp).

### DETAILED DESCRIPTION OF EMBODIMENTS

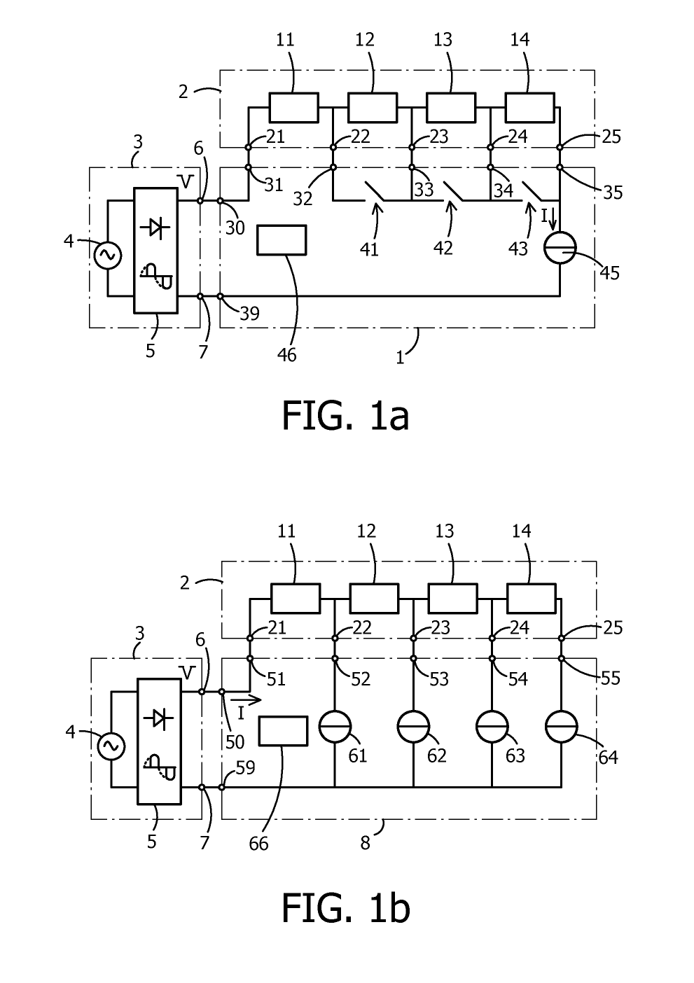

FIG. 1a depicts an embodiment of an LED driver circuit 1 for driving a LED module 2. The LED driver circuit 1 is adapted to be coupled to a power supply 3 which may comprise an AC mains voltage supply 4 coupled to a rectifier and dimming device 5.

The power supply 3 has output terminals 6, 7 for supplying a rectified AC voltage according to the voltage amplitude and frequency used locally. The voltage supplied by the power supply 3 may be a forward phase-cut voltage or a reverse phase-cut voltage to provide a dimming function by varying the average voltage at the output terminals, depending on the cutting angle set automatically or by a user in the rectifier and dimming device 5.

The LED module 2 comprises a plurality of LED segments 11, 12, 13, 14 connected in series. Each LED segment 11, 12, 13, 14 may comprise one or more LEDs mutually connected as desired. The voltage of each LED segment 11, 12, 13, 14 may be the same as, or different from, that of other segments, for example about 30 V, about 36 V, or about 70 V. The number of LED segments in a LED module may be chosen differently, and is at least two. The LED module 2 has terminals 21, 22, 23, 24, and 25, so that each LED segment is accessible by two terminals. LED segment 11 has terminals 21 and 22, LED segment 12 has terminals 22 and 23, LED segment 13 has terminals 23 and 24, and LED segment 14 has terminals 24 and 25. Each of the terminals 21, 22, 23, 24 and 25 is available for coupling to a LED driver circuit 1.

The LED driver circuit 1 comprises a plurality of terminals 30, 31, 32, 33, 34, 35 and 39. Terminals 30 and 39 are adapted to be coupled to output terminals 6, 7 of the power supply 3. Terminals 31, 32, 33, 34 and 35 are adapted to be coupled to the terminals 21, 22, 23, 24 and 25, respectively, of the LED module 2. The LED driver circuit 1 comprises switching devices 41, 42 and 43 connected between terminals 32 and 33, 33 and 34, and 34 and 35, respectively. Examples of switching devices suitable for use in the LED driver circuit 1 are switchable transistors, such as field effect transistors or bipolar transistors. A current control device 45 is connected between terminals 35 and 39 of the LED driver circuit 1. The LED driver circuit 1 further comprises control circuitry 46 operatively connected to the switching devices 41, 42 and 43 for, in use, bringing the switching devices 41, 42 and 43 in an open state (non-conducting) or a closed state (conducting) at a desired timing. An example of such timed operation is given below. The control circuitry 46 may further optionally be operatively connected to the current control device 45 to control, in operation, the current flowing through the current control device 45 at a desired timing, which may also be pulse-width modulation.

It is noted that in an alternative embodiment, the rectifier and dimmer device 5 may be part of the LED driver circuit 1.

The combination of the LED driver circuit 1 and the LED module 2 will be referred to as LED lighting module.

FIG. 1b depicts an embodiment of an LED driver circuit 8 for driving the LED module 2 from the power supply 3. The configuration of the LED module 2 and the power supply 3 may be similar or identical to the configurations as explained with reference to FIG. 1a, and the same reference numerals have been used to identify components thereof.

The LED driver circuit 8 comprises a plurality of terminals 50, 51, 52, 53, 54, 55 and 59. Terminals 50 and 59 are adapted to be coupled to output terminals 6, 7 of the power supply 3. Terminals 51, 52, 53, 54 and 55 are adapted to be coupled to the terminals 21, 22, 23, 24 and 25, respectively, of the LED module 2. The LED driver circuit 8 comprises a plurality of current control devices 61, 62, 63 and 64 connected between terminals 52 and 59, 53 and 59, 54 and 59, and 55 and 59, respectively. The LED driver circuit 8 may further optionally comprise control circuitry 66 operatively connected to the current control devices 61, 62, 63 and 64 to control, in operation, the current flowing through each of the current control devices 61, 62, 63, 64. An example of such operation is given below.

An LED segment 11, 12, 13, 14 emits a distinct color of light, when in use. The following colors of light are distinguished:
cold white (CW) light having a high color temperature, e.g. of about 5,000 K;
neutral white or normal white (NW) light having a color temperature lower than cold white, e.g. of about 4,000 K;
warm white (WW) light, such as yellow or orange light, having a color temperature lower than NW;
amber (AM) light having a color temperature lower than WW;
red (RD) light having a color temperature lower than AM;

In the LED module 2, at least one of the LED segments emits NW light, WW light, AM light and/or RD light, and at least another one of the LED segments emits CW light, NW light (when said at least one LED segment does not emit NW light) and/or WW light (when said at least one LED segment does not emit NW or WW light). Thus, the following combinations of light emitted by different LED segments 11, 12, 13 and 14 may be present according to Table I below, where X indicates a combination of the light in the same column and row:

TABLE 1
color combinations in LED module

| | NW | WW | AM | RD |
|---|---|---|---|---|
| CW | X | X | X | X |
| NW | | X | X | X |
| WW | | | X | X |

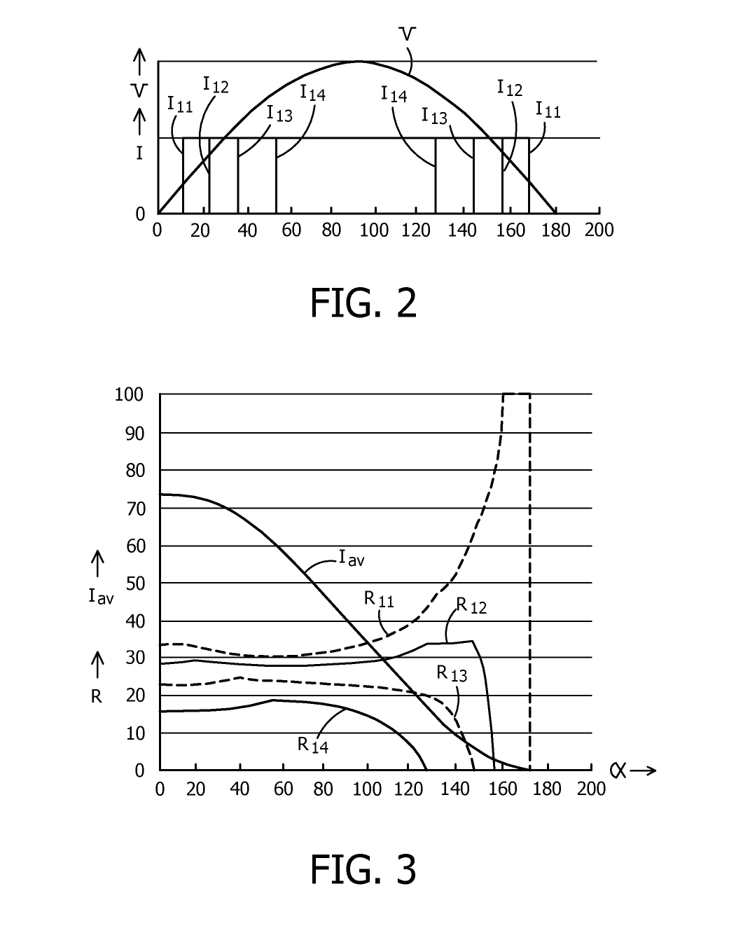

FIG. 2 illustrates an operation of an embodiment of the circuit of FIG. 1a, wherein LED segment 11 emits WW or RD or AM or RD/AM light, and at least one of the other LED segments 12, 13 and 14 emits light having a higher color temperature than LED segment 11. The mode of operation is constant current delivered by the power supply 3. In this mode of operation, the current through the LED segments is not adjusted as a function of the number of LED segments turned on.

In FIG. 2, curve V represents the rectified mains voltage V. As shown by curve V, in a half cycle (phase angle running from 0-180 degrees) of the rectified mains voltage, the amplitude of the voltage V increases from zero value at 0 degrees to a top value at 90 degrees, and back to zero value at 180 degrees.

It is assumed that all LED segments 11, 12, 13, 14 have about the same on-voltage. It is further assumed that at 0 degrees all switching devices 41, 42 and 43 are in a closed state, or that at least one of the switching devices 41, 42 and 43 is in an open state.

When the voltage V increases from 0 degrees onwards, at about 11 degrees the voltage V is at a first level sufficient for a current I, amplitude-controlled by the current control device 45, to run in the LED segment 11. At that time, all switching devices 41, 42 and 43 should be in a closed state, or be brought into a closed state, and the current I will flow through the LED segment 11, the closed switches 41, 42 and 43, and the current control device 45. The value of the current I flowing through the LED segment 11 is indicated by I11.

At about 23 degrees, the voltage V is at a second level sufficient for the LED segments 11 and 12 to be conducting, and for the current I, still controlled in amplitude by the current control device 45, to run in the series connection of LED segments 11 and 12. At that time, the switching device 41 should be brought into an open state, while the switching devices 42 and 43 remain in a closed state, to allow the current I, already flowing through LED segment 11, to run also in LED segment 12. The current flowing through LED segment 12 is indicated by I12.

At about 36 degrees, the voltage V is at a third level sufficient for the LED segments 11, 12 and 13 to be conducting, and for the current I, still controlled in amplitude by the current control device 45, to run in the series connection of LED segments 11, 12 and 13. At that time, the switching device 41 should remain in an open state, the switching device 42 should be brought into an open state, and the switching device 43 should remain in a closed state, to allow the current I, already flowing through LED segments 11 and 12, to run also in LED segment 13. The current flowing through LED segment 13 is indicated by I13.

At about 52 degrees, the voltage V is at a fourth level sufficient for the LED segments 11, 12, 13 and 14 to be conducting, and for the current I, still controlled in amplitude by the current control device 45, to run in the series connection of LED segments 11, 12, 13 and 14. At that time, the switching devices 41 and 42 should remain in an open state, and the switching device 43 should be brought into an open state, to allow the current I, already flowing through LED segments 11, 12 and 13, to run also in LED segment 14. The current flowing through LED segment 14 is indicated by I14.

Between about 52 and about 128 degrees, the voltage V remains above the fourth level sufficient for the LED segments 11, 12, 13 and 14 to be conducting, and for the current I, still controlled in amplitude by the current control device 45, to run in the series connection of LED segments 11, 12, 13 and 14. All switching devices 41, 42 and 43 remain open.

At about 128 degrees, the voltage V decreases to below the fourth level, and becomes insufficient for the LED segment 14 to be conducting, but still is sufficient for the LED segments 11, 12 and 13 to be conducting, and for the current I, still controlled in amplitude by the current control device 45, to run in the series connection of LED segments 11, 12 and 13. At that time the switching device 43 should be brought into a closed state, while the switching devices 41 and 42 remain in an open state, to allow the current I to continue running in the LED segments 11, 12 and 13. Current I14 becomes zero.

At about 144 degrees, the voltage V decreases to below the third level, and becomes insufficient for the LED segment 13 to be conducting, but still is sufficient for the LED segments 11 and 12 to be conducting, and for the current I, still controlled in amplitude by the current control device 45, to run in the series connection of LED segments 11 and 12. At that time the switching device 42 should be brought into a closed state, while the switching device 41 remains in an open state and the switching device 43 remains in a closed state, to allow the current I to continue running in the LED segments 11 and 12. Current I13 becomes zero.

At about 157 degrees, the voltage V decreases to below the second level, and becomes insufficient for the LED segment 12 to be conducting, but still is sufficient for the LED segment 11 to be conducting, and for the current I, still controlled in amplitude by the current control device 45, to run in LED segment 11. At that time the switching device 41 should be brought into a closed state, while the switching devices 42 and 43 remain in a closed state, to allow the current I to continue running in the LED segment 11. Current I12 becomes zero.

At about 169 degrees, the voltage V decreases to below the first level, and becomes insufficient for the LED segment 11 to be conducting. Current I11 becomes zero.

Beyond about 169 degrees, each of the switching devices may be in an open or closed state. The voltage V is insufficient for a current I to flow in any of the LED segments 11, 12, 13 or 14.

FIG. 3 illustrates the light output ratios R of the LED segments 11 (ratio R11), 12 (ratio R12), 13 (ratio R13) and 14 (ratio R14) compared with the total light output of the LED module 2 (vertical axis) at a variation of a phase-cutting angle α of the AC mains voltage (horizontal axis) in the rectifier and dimming device 5, for each LED segment 11, 12, 13, 14. At every phase-cutting angle α, the following equation holds true: R11+R12+R13+R14=100%.

When the phase-cutting angle α is 0 degrees (no phase cutting), then the ratio R11 of the light output of LED segment 11 in the total light output of the LED module 2 as seen over a half cycle of the AC mains voltage, is about 33%. For LED segments 12, 13 and 14, the ratios R12, R13 and R14 are about 28%, 23% and 16%, respectively.

As can be understood from FIG. 2, and can be seen in FIG. 3, the ratios R11, R12, R13 and R14 remain the same when the phase-cutting angle α is between 0 degrees and 11 degrees, since it does not affect the conduction times of any of the LED segments. As can further be understood from FIG. 2, and can be seen in FIG. 3, the ratio R14 becomes zero when the phase-curring angle α is greater than 128 degrees, since LED segment 14 cannot conduct at such phase-cutting angles α. When the phase-cutting angle α is greater than 144 degrees, the ratio R13 becomes zero, since LED segment 13 cannot conduct at such phase-cutting angles α. When the phase-cutting angle α is greater than 157 degrees, the ratio R12 becomes zero, since LED segment 12 cannot conduct at such phase-cutting angles α. When the phase-cutting angle α is between 157 and 169 degrees, the ratio R11 becomes 100%, since LED segment 11 is the only one which would come into a conducting state during a half cycle of the voltage V. When the phase-cutting angle α is greater than 169 degrees, the ratio R11 becomes zero, since LED segment 11 cannot conduct at such phase-cutting angles α. In fact, none of the LED segments 11, 12, 13 or 14 can conduct when the phase-cutting angle α is greater than 169 degrees.

In FIG. 3, curve Iav shows the average current through the LED segments 11, 12, 13, 14 at different phase-cutting angles α.

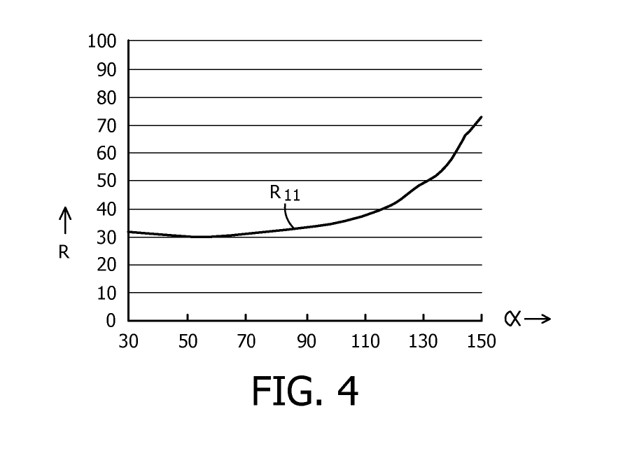

FIG. 4 shows a detail of FIG. 3, i.e. curve R11 for phase-cutting angles between 30 degrees and 150 degrees, which is a typical operating range for a rectifier and dimming device 5. As illustrated by FIG. 3, for LED segments 12, 13 and 14, the respective ratios R12, R13 and R14 remain substantially the same, or decrease, when the phase-cutting angle α increases within the operating range of FIG. 4. However, the ratio R11 increases significantly when the phase-cutting angle α increases within the operating range of FIG. 4.

When the color temperature of the light emitted by the LED segment 11 is lower than the color temperature of at least one of the other LED segments 12, 13, 14, the effect of dimming the LED string of the LED module 2 is that the color temperature of the light emitted by the LED module 2 decreases when the phase-cutting angle α increases, due to the LED segment 11 becoming dominant over the other LED segments 12, 13, 14, or in other words: the ratio R11 increases more than any of the ratios R12, R13, R14. As a result, when dimming the LED module 2, the (overall) color temperature of the emitted light decreases similarly to that of an incandescent lamp. This effect is favoured. The user of the LED module perceives a color behavior which resembles a BBL (black body line) behavior.

As an example, at least the LED segment 11 may emit RD light, or RD/AM light, whereas at least one of the other LED segments 12, 13 and 14 may emit WW, NW and/or CW light.

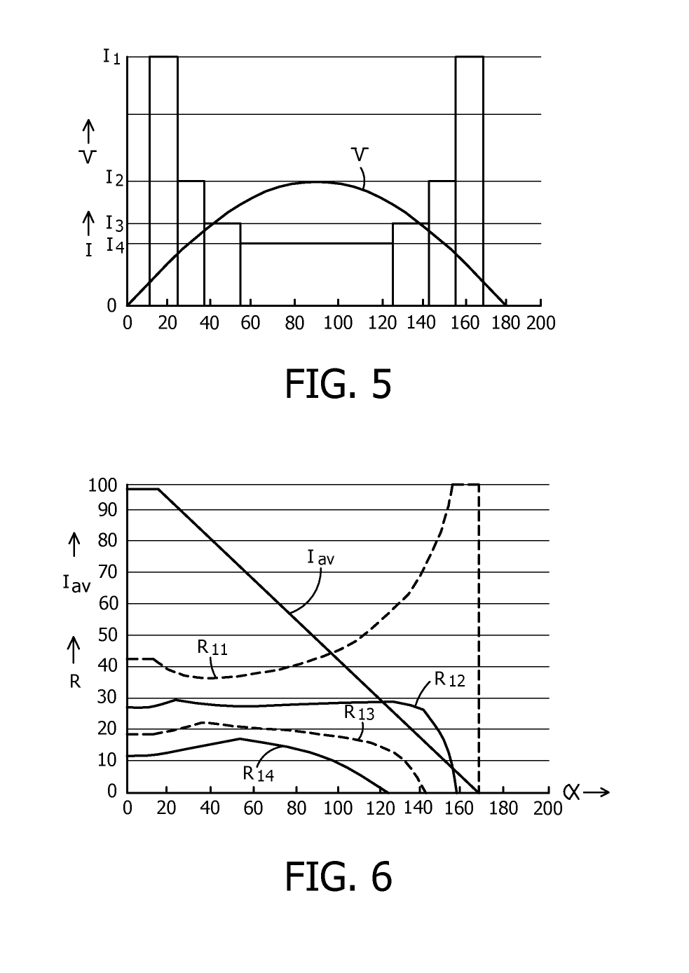

FIG. 5 illustrates an operation of an embodiment of the circuit of FIG. 1b, wherein the LED segment 11 emits WW or RD or AM or RD/AM light, and at least one of the LED segments 12, 13 and 14 emits light having a higher color temperature that the LED segment 11. The mode of operation is constant power delivered by the power supply 3. In this mode of operation, the current through the LED segments is adjusted as a function of the number of LED segments turned on.

In FIG. 5, curve V represents a half cycle (phase angle running from 0-180 degrees) of the rectified mains voltage V.

It is assumed that all LED segments 11, 12, 13, 14 have about the same on-voltage.

When the voltage V increases from 0 degrees onwards, at about 11 degrees the voltage V is at a first level sufficient for a current I having a value I1, amplitude-controlled by current control device 61, to run in LED segment 11. No current flows in the other LED segments 12, 13, 14.

At about 23 degrees, the voltage V is at a second level sufficient for the LED segments 11 and 12 to be conducting. The current I is adjusted to have a value I2, amplitude-controlled by current control device 62, to run in series-connected LED segments 11 and 12. Current control device 61 is controlled by control circuitry 66 not to conduct current. No current flows in the other LED segments 13 and 14.

At about 36 degrees, the voltage V is at a third level, sufficient for the LED segments 11, 12 and 13 to be conducting. The current I is adjusted to have a value I3, amplitude-controlled by current control device 63, to run in series-connected LED segments 11, 12 and 13. Current control devices 61 and 62 are controlled by control circuitry 66 not to conduct current. No current flows in the LED segment 14.

At about 52 degrees, the voltage V is at a fourth level, sufficient for the LED segment 11, 12, 13 and 14 to be conducting. The current is adjusted to have a value I4, amplitude-controlled by current control device 64, to run in series-connected LED segments 11, 12, 13 and 14. Current control devices 61, 62 and 63 are controlled by control circuitry 66 not to conduct current.

Between about 52 and about 128 degrees, the voltage V remains above the fourth level, sufficient for the LED segments 11, 12, 13 and 14 to be conducting, and for the current I, still controlled in amplitude by the current control device 64, to run in the series connection of LED segments 11, 12, 13 and 14. All current control devices 61, 62 and 63 are in an open state, i.e. do not conduct current.

At about 128 degrees, the voltage V decreases to below the fourth level, and becomes insufficient for the LED segment 14 to be conducting, but still is sufficient for the LED segments 11, 12 and 13 to be conducting, and for the current I to run in the series connection of LED segments 11, 12 and 13. At that time, the current control device 63 adjusts the amplitude of the current I to a value I3. Current control devices 61 and 62 are controlled by control circuitry 66 not to conduct current.

At about 144 degrees, the voltage V decreases to below the third level, and becomes insufficient for the LED segments 13 and 14 to be conducting, but still is sufficient for the LED segments 11 and 12 to be conducting, and for the current I to run in the series connection of LED segments 11 and 12. At that time, the current control device 62 adjusts the amplitude of the current I to a value I2. Current control device 61 is controlled by control circuitry 66 not to conduct current.

At about 157 degrees, the voltage V decreases to below the second level, and becomes insufficient for the LED segments 12, 13 and 14 to be conducting, but still is sufficient for the LED segment 11 to be conducting, and for the current I to run in LED segment 11. At that time, the current control device 61 adjusts the amplitude of the current I to a value I1.

At about 169 degrees, the voltage V decreases to below the first level, and becomes insufficient for LED segment 11 to be conducting. Current I becomes zero.

After about 169 degrees, the voltage V is insufficient to have a current I flow in any of the LED segments 11, 12, 13 or 14.

FIG. 6 illustrates the light output ratios R of the LED segments 11 (ratio R11), 12 (ratio R12), 13 (ratio R13) and 14 (ratio R14) compared with the total light output of the LED module 2 (vertical axis) at a variation of a phase-cutting angle α of the AC mains voltage (horizontal axis) in the rectifier and dimming device 5, for each LED segment 11, 12, 13, 14. At every phase-cutting angle α, the following equation holds true: R11+R12+R13+R14=100%.

When the phase-cutting angle α is 0 degrees (no phase cutting), the ratio R11 of the light output of LED segment 11 in the total light output of the LED module 2 as seen over a half cycle of the AC mains voltage, is about 42%. For LED segments 12, 13 and 14, the ratios R12, R13 and R14 are about 27%, 19% and 12%, respectively.

As can be understood from FIG. 5, and can be seen in FIG. 6, the ratios R11, R12, R13 and R14 remain the same when the phase-cutting angle α is between 0 degrees and 11 degrees, since it does not affect the conduction times of any of the LED segments. As can further be understood from FIG. 5, and can be seen in FIG. 6, the ratio R14 becomes zero when the phase-cutting angle α is greater than 128 degrees, since LED segment 14 cannot conduct at such phase-cutting angles α. When the phase-cutting angle α is greater than 144 degrees, the ratio R13 becomes zero, since LED segment 13 cannot conduct at such phase-cutting angles α. When the phase-cutting angle α is greater than 157 degrees, the ratio R12 becomes zero, since LED segment 12 cannot conduct at such phase-cutting angles α. When the phase-cutting angle α is between 157 and 169 degrees, the ratio R11 becomes 100%, since LED segment 11 is the only one which would come into a conducting state during a half cycle of the voltage V. When the phase-cutting angle α is greater than 169 degrees, the ratio R11 becomes zero, since LED segment 11 cannot conduct at such phase-cutting angles α. In fact, none of the LED segments 11, 12, 13 or 14 can conduct when the phase-cutting angle α is greater than 169 degrees.

In FIG. 6, curve lay shows the average current through the LED segments 11, 12, 13, 14 at different phase-cutting angles α.

It follows from FIG. 6 that the effect of dimming the LED string of the LED module 2 is that the color temperature of the light emitted by the LED module 2 decreases when the phase-cutting angle α increases, due to the LED segment 11 becoming dominant over the other LED segments 12, 13, 14, or in other words: the ratio R11 increases more than any of the ratios R12, R13, R14. As a result, when dimming the LED module 2, the (overall) color temperature of the emitted light decreases similarly to that of an incandescent lamp.

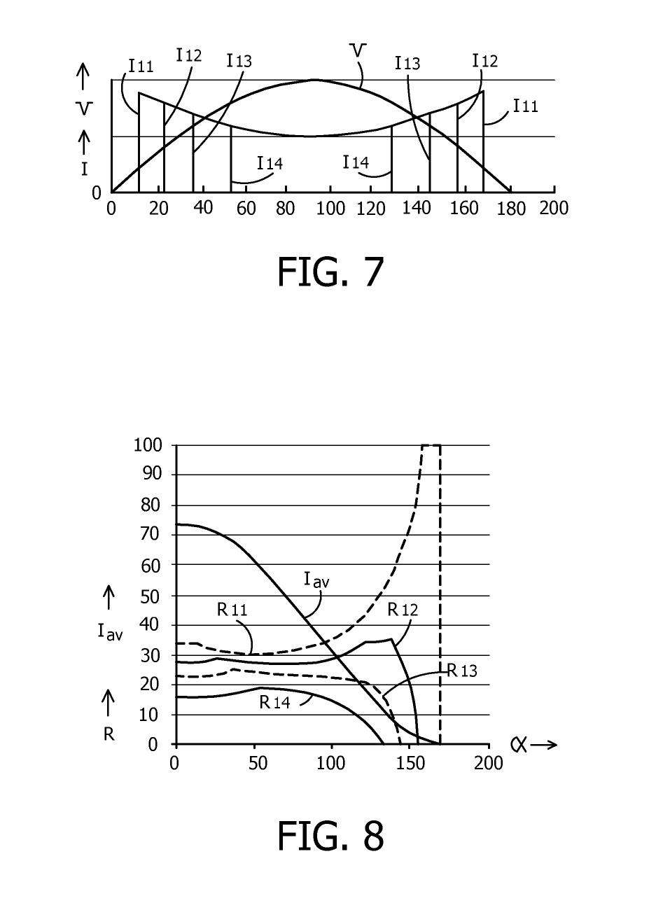

FIG. 7 illustrates an operation of an embodiment of the circuit of FIG. 1a, wherein the LED segment 11 emits WW or RD or AM or RD/AM light, and at least one of the LED segments 12, 13 and 14 emits light having a higher color temperature than the LED segment 11. The mode of operation is to deliver 50% modulated LED segment current by the power supply 3. In this mode of operation, the current through the LED segments varies over a half cycle of the voltage V.

In FIG. 7, curve V represents a half cycle (0-180 degrees) of the rectified mains voltage V.

It is assumed that all LED segments 11, 12, 13, 14 have about the same on-voltage.

For a description of the circuit of FIG. 1a in the mode of operation illustrated in FIG. 7, reference is made to the description of FIG. 3 above, wherein the only difference is that once a current I flows through an LED segment, it is 50% pulse width modulated.

FIG. 8 illustrates the ratios R of the light output of the LED segments 11 (ratio R11), 12 (ratio R12), 13 (ratio R13) and 14 (ratio R14) compared with the total light output of the LED module 2 (vertical axis) at a variation of a phase-cutting angle α of the AC mains voltage (horizontal axis) in the rectifier and dimming device 5, for each LED segment 11, 12, 13, 14. At every phase-cutting angle α, the following equation holds true: R11+R12+R13+R14=100%.

When the phase-cutting angle α is 0 degrees (no phase cutting), the ratio R11 of the light output of LED segment 11 in the total light output of the LED module 2 as seen over a half cycle of the AC mains voltage, is about 33%. For LED segments 12, 13 and 14, the ratios R12, R13 and R14 are about 28%, 23% and 16%, respectively.

As can be understood from FIG. 7, and can be seen in FIG. 8, the ratios R11, R12, R13 and R14 remain the same when the phase-cutting angle α is between 0 degrees and 11 degrees, since it does not affect the conduction times of any of the LED segments. As can further be understood from FIG. 7, and can be seen in FIG. 8, the ratio R14 becomes zero when the phase-curring angle α is greater than 128 degrees, since LED segment 14 cannot conduct at such phase-cutting angles α. When the phase-cutting angle α is greater than 144 degrees, the ratio R13 becomes zero, since LED segment 13 cannot conduct at such phase-cutting angles α. When the phase-cutting angle α is greater than 157 degrees, the ratio R12 becomes zero, since LED segment 12 cannot conduct at such phase-cutting angles α. When the phase-cutting angle α is between 157 and 169 degrees, the ratio R11 becomes 100%, since LED segment 11 is the only one which would come into a conducting state during a half cycle of the voltage V. When the phase-cutting angle α is greater than 169 degrees, the ratio R11 becomes zero, since LED segment 11 cannot conduct at such phase-cutting angles α. In fact, none of the LED segments 11, 12, 13 or 14 can conduct when the phase-cutting angle α is greater than 169 degrees.

In FIG. 8, curve lay shows the average current through the LED segments 11, 12, 13, 14 at different phase-cutting angles α.

It follows from FIG. 8 that the effect of dimming the LED string of the LED module 2 is that the color temperature of the light emitted by the LED module 2 decreases when the phase-cutting angle α increases, due to the LED segment 11 becoming dominant over the other LED segments 12, 13, 14, or in other words: the ratio R11 increases more than any of the ratios R12, R13, R14. As a result, when dimming the LED module 2, the (overall) color temperature of the emitted light decreases similarly to that of an incandescent lamp.

When comparing FIG. 3 (in conjunction with 4), 6 and 8, it appears that in all three scenarios, for LED segments 12, 13 and 14, the respective ratios R12, R13 and R14 remain substantially the same, or decrease, in a representative operating range of the phase-cutting angle α, such as the operating range illustrated in FIG. 4. However, the ratio R11 increases significantly when the phase-cutting angle α increases within the operating range. The ratio R11 may additionally be adjusted by adjusting the current flowing through LED segment 11 by a predetermined control of the current control devices 45 (FIGS. 1a, 2, 3, 4, 7 and 8) or 61 (FIGS. 1b, 5 and 6), respectively, possibly supplemented by a predetermined control of the current control devices 62, 63 and/or 64 (FIGS. 1b, 5 and 6).

It is noted that the LED driver circuit 1 in FIG. 1a has switching devices 41, 42 and 43 adapted to be connected in parallel with respective LED segments 12, 13 and 14. For LED segment 11, a switching device is not present. However, in an alternative embodiment of the LED driver circuit 1, also LED segment 11 may have a switching device connected in parallel with it, and operatively connected to control circuitry 46 for controlled opening and closing of the switching device. In such circumstances, when the voltage V is at a first level, any of the LED segments 11, 12, 13, 14 may be selected to conduct current I, by bringing its corresponding switching device into an open state. This means that the LED segment 11, in that case, does not need to be the first LED segment to be conducting, and does not need to emit light having a color temperature which is lower than the color temperature of at least one of the other LED segments. The first LED segment to be conducting and to emit light having a color temperature which is lower than the color temperature of at least one of the other LED segments may be selected to be any of the LED segments 11, 12, 13 or 14 when the LED driver circuit has a switching device adapted to be connected in parallel to each one of the LED segments.

In the above description of operations of the LED driver circuits 1 and 8 as shown in FIGS. 1a and 1b, respectively, it has been assumed that all LED segments have about the same on-voltage, i.e. the voltage at which the LED segment starts to conduct current. However, different LED segments may have different on-voltages, which will influence the phase angles at which the LED segment concerned may start or finish to conduct and emit light.

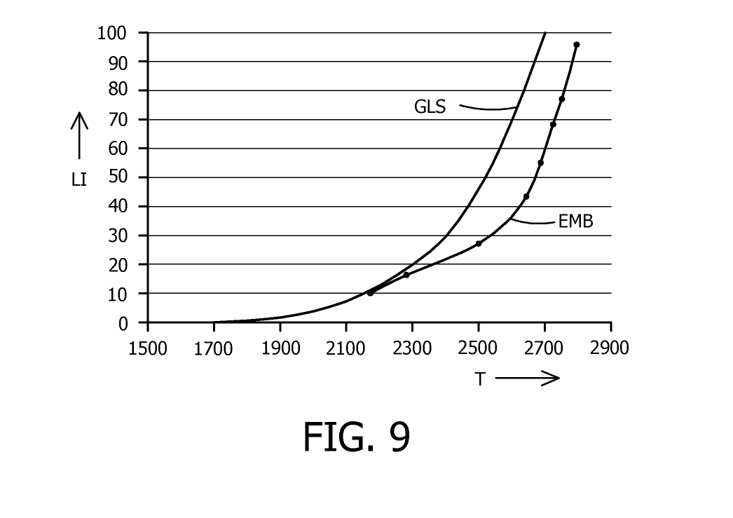

FIG. 9 shows a first graph, marked EMB, of measurements of the color temperature T (K) of an embodiment of a LED module containing six LED segments of 50 V each, of which the first LED segment emits amber light, and the other five LED segments emit white light, plotted against the light intensity LI (%) of the LED module over a dimming range. For comparison, the color temperature of a common GLS (incandescent lamp) versus its light intensity has been plotted in the same diagram. As can be seen, both for the LED module and for the GLS, the color temperature of the emitted light decreases in a similar way, demonstrating that the LED module shows a similar color temperature behaviour of its emitted light as a GLS.

The invention as illustrated and described above is generally applicable for different mains voltages and mains frequencies, such as 230 V, 50 Hz in Europe or 110 V, 60 Hz in the USA. At 50 Hz, a half cycle (0-180 degrees) of the mains voltage takes 10 ms. At 60 Hz, a half cycle of the mains voltage takes 0.83 ms.

The LED module 2 may comprise at least two LED segments.

As explained above, the invention relates to a method and a device for driving an LED string of a first LED segment and at least one further LED segment connected in series. Each LED segment has at least one light emitting diode, LED. The LED string is powered by a rectified AC mains voltage. The first LED segment is powered when the rectified AC mains voltage is above a first voltage level, and the first LED segment and the further LED segment are powered when the rectified AC mains voltage is above a second voltage level higher than the first voltage level. The first LED segment emits light having a first color temperature, and the further LED segment emits light having a second color temperature higher than the first color temperature. The color temperature change of the light emitted by the LED string, when dimmed, resembles the color temperature change of an incandescent lamp.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

1. A method of driving an LED string comprising a first LED segment and at least one further LED segment connected in series, each LED segment comprising at least one light emitting diode, LED, the LED string being powered by a rectified AC mains voltage,
wherein the first LED segment is powered when the rectified AC mains voltage is above a first voltage level, and the first LED segment and the further LED segment are powered when the rectified AC mains voltage is above a second voltage level higher than the first voltage level,
wherein the first LED segment emits light having a first color temperature, and the further LED segment emits light having a second color temperature higher than the first color temperature, and the light emitted by the first LED segment and the light emitted by the further LED segment are superimposed.

2. The method of claim 1, wherein the first LED segment emits red, orange, yellow or amber light.

3. The method of claim 1, wherein the AC mains voltage is phase-cut dimmed or voltage amplitude dimmed.

4. An LED lighting module comprising:
an LED module comprising a string of a first LED segment and at least one further LED segment connected in series, wherein each LED segment comprises at least one light emitting diode, LED;
an LED driver circuit comprising:
LED driver input terminals adapted to be connected to a rectified AC mains voltage;
a switching device connected in parallel to each further LED segment;
a current control device connected between the LED driver input terminals;
control circuitry for controlling an open state or a closed state of each switching device, the control circuitry being adapted to control each switching device to have a closed state when the rectified AC mains voltage is below a predetermined voltage level, and to control the switching device connected to a further LED segment to have an open state when the rectified AC mains voltage is above the predetermined voltage level,
wherein the first LED segment emits light having a first color temperature, and the further LED segment emits light having a second color temperature higher than the first color temperature, and the light emitted by the first LED segment and the light emitted by the further LED segment are superimposed.

5. An LED lighting module comprising:
an LED module comprising a string of a first LED segment and at least one further LED segment connected in series, wherein each LED segment comprises at least one light emitting diode, LED;
an LED driver circuit comprising:
LED driver input terminals adapted to be connected to a rectified AC mains voltage;
a switching device connected in parallel to the first LED segment, and a switching device connected in parallel to each further LED segment;
a current control device connected between the LED driver input terminals;
control circuitry for controlling an open state or a closed state of each switching device, the control circuitry being adapted to control the switching device connected in parallel to the first LED segment to have an open state and the switching device connected in parallel to a further LED segment to have a closed state when the rectified AC mains voltage is above a first voltage level and below a second voltage level higher than the first voltage level, and to control the switching device connected to a further LED segment to have an open state when the rectified AC mains voltage is above the second voltage level,
wherein the first LED segment emits light having a first color temperature, and the further LED segment emits light having a second color temperature higher than the first color temperature, and the light emitted by the first LED segment and the light emitted by the further LED segment are superimposed.

6. An LED lighting module comprising:
an LED module comprising a string of a first LED segment and at least one further LED segment connected in series, wherein each LED segment comprises at least one light emitting diode, LED;
an LED driver circuit comprising:
LED driver input terminals adapted to be connected to a rectified AC mains voltage;
for each LED segment, a current control device connected between one terminal of the LED segment and an LED driver input terminal;
control circuitry for controlling a current in each current control device, the control circuitry being adapted to control the current control device of the first LED segment to allow a current to flow when the rectified AC mains voltage is above a first voltage level, and to disallow a current to flow when the rectified AC mains voltage is above a second voltage level higher than the first voltage level,
wherein the first LED segment emits light having a first color temperature, and the further LED segment emits light having a second color temperature higher than the first color temperature, and the light emitted by the first LED segment and the light emitted by the further LED segment are superimposed.

7. The LED lighting module of claim 4, wherein at least one of the current control devices is adapted to pulse-width modulate the current flowing through it.

8. (canceled)
